(19) United States
(12) Patent Application Publication
(10) Pub. No.: US 2025/0358356 A1
(43) Pub. Date: Nov. 20, 2025

(54) Crib Clock Device, System and Method

(71) Applicant: Kylie Teschke, Wyoming (CA)

(72) Inventor: Kylie Teschke, Wyoming (CA)

(21) Appl. No.: 18/667,754

(22) Filed: May 17, 2024

(51) Int. Cl. H04M 1/72412

(52) U.S. Cl. CPC H04M 1/72412

(57) ABSTRACT

A sleep tracking device, system and method is disclosed herein. In some versions, the sleep tracking system includes the sleep tracking device and a software application, such as a smartphone ‘app’, installed on a mobile device. The sleep tracking device includes a timer module and is able to record a time at which the timer module was started and/or a time elapsed since the timer module was started. This information is transmitted to the software application and is able to be viewed by a user, such as a parent, via the mobile device. The sleep tracking device, system and method are particularly useful for timing naps of a child.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

The present invention relates generally to the field of timers of existing art and more specifically relates to a device for tracking sleep time of a child.

Establishing a consistent sleep schedule, including scheduled naps, is crucial for the well-being and development of children. Naps play a vital role in replenishing energy levels, enhancing cognitive function, and promoting emotional regulation. The timing of naps is equally important, as it can affect a child's overall sleep quality and behavior. Ensuring that naps are scheduled at appropriate times, such as mid-morning or early afternoon, aligns with children's natural sleep rhythms and prevents them from becoming overtired or irritable.

Timing naps appropriately and ensuring they don't extend too long is essential for maintaining a child's sleep routine and overall well-being. While naps provide much-needed rest and rejuvenation, allowing them to go on for too long can disrupt a child's nighttime sleep schedule and lead to difficulties falling asleep or staying asleep at night. Further, excessively long naps can interfere with the child's daily routine, affecting mealtimes, playtime, and other activities. However, for busy parents juggling multiple responsibilities, remembering to time naps or recall when their baby was put down for a nap can be challenging. With hectic schedules and numerous tasks demanding attention, these times are easy to slip from the memory. Accordingly, a suitable solution is desired.

### SUMMARY OF THE INVENTION

In view of the foregoing disadvantages inherent in the known timer art, the present disclosure provides a novel crib clock device, system and method. The general purpose of the present disclosure, which will be described subsequently in greater detail, is to provide a device that attaches to, or near to, a crib, and times the sleep of a child. The device is also able to communicate with a software app to enable a parent to view the time being tracked by the device.

A sleep tracking system is disclosed herein. According to one or more embodiments, the sleep tracking system may include a sleep tracking device configured for attachment near to a sleeping child, and a software application installed on a mobile device. The sleep tracking device may include a housing, a timer module disposed in the housing and configured to track time, a user interface disposed at an exterior of the housing and configured to start and stop operation of the timer module, and a wireless communication module disposed in the housing and configured to transmit data pertaining to the time tracked by the timer module.

The software application may be in wireless communication with the sleep tracking device via the wireless communication module such that the software application is able to receive the data pertaining to the time tracked by the timer module, thereby enabling a user of the mobile device to view the data pertaining to the time tracked by the timer module via the software application.

According to another embodiment, a sleep tracking device is also disclosed herein. According to one or more embodiments, the sleep tracking device may include a housing for attachment near to a sleeping child; a timer module disposed in the housing and configured to track time; a start button disposed at an exterior of the housing and configured to start operation of the timer module; a stop button disposed at an exterior of the housing and configured to stop operation of the timer module; a controller disposed in the housing and configured to generate data pertaining to time tracked by the timer module; a display disposed at the exterior of the housing configured to display the data pertaining to the time tracked by the timer module; and a wireless communication module disposed in the housing and configured to transmit data pertaining to the time tracked by the timer module to a mobile device running a software application.

According to another embodiment, a method of tracking a child's sleep is also disclosed herein. According to one or more embodiments, the method may comprise the steps of: providing the sleep tracking system as above; attaching, by a user, the sleep tracking device near to a sleeping child; starting, by the user at the user interface or the software application, operation of the timer module; tracking, by the timer module, time; transmitting, by the wireless communication module, data pertaining to time tracked by the timer module to the software application on the mobile device; viewing, by the user, the data pertaining to the time tracked by the timer module via the software application on the mobile device; and stopping, by the user at the user interface or the software application, operation of the timer module when desired.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF FIGURES

The figures which accompany the written portion of this specification illustrate embodiments and methods of use for the present disclosure, a crib clock device, system and method, constructed and operative according to the teachings of the present disclosure.

FIG. 1 is a perspective view of a sleep tracking system including a sleep tracking device attached to a crib, according to an embodiment of the disclosure.

FIG. 2 is a diagram of the sleep tracking device and a software application installed on a mobile device, according to an embodiment of the present disclosure.

FIG. 3 is a schematic diagram demonstrating communication between the sleep tracking device and the software application on the mobile device, according to an embodiment of the present disclosure.

FIG. 4 is another schematic diagram demonstrating communication between the sleep tracking device and the software application on the mobile device, according to an embodiment of the present disclosure.

FIG. 5 is a flow diagram illustrating a method of tracking a child's sleep, according to an embodiment of the present disclosure.

FIG. 6 is another flow diagram illustrating the method of tracking a child's sleep, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a crib clock device, system and method. Generally, the crib clock device may attach to a crib and time a child's sleep from the crib. Particularly, the crib clock device may record the exact time the child started their sleep, time the child's sleep, and connect to a mobile device, such as a smartphone, to enable parents to view the time the child started the sleep and/or the time elapsed since the child started the sleep.

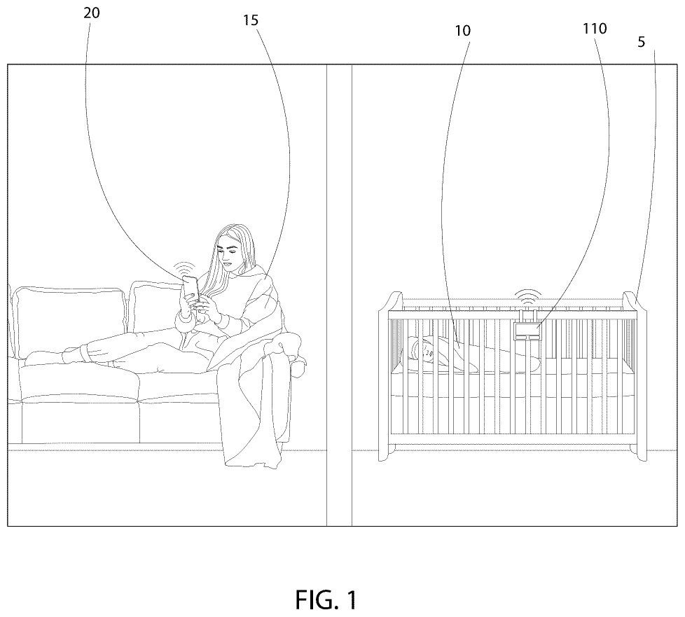

Referring now more specifically to the drawings by numerals of reference, there is shown in FIGS. 1-4, various views of a sleep tracking system 100.

Referring first to FIG. 1, shown here is a perspective view of a child 10 asleep in a crib 5 in a bedroom, and a user 15 (e.g., parent) in a separate room utilizing a mobile device 20 to view information pertaining to the sleep time of the child 10, according to one or more embodiments of the present disclosure. As has been discussed above and as is shown here, the sleep tracking system 100 is particularly useful for keeping track of sleep for children, particularly babies, for whom it is essential to keep to a sleep schedule.

As shown here, the sleep tracking system 100 may include a sleep tracking device 110. The sleep tracking device 110 may be configured for attachment near to a sleeping child 10, so that the user 15 is able to simply operate the sleep tracking device 110 when putting the child 10 down for their sleep. In particular, as shown here, the sleep tracking device 110 may attach directly to a crib 5 in which the child 10 is sleeping. For example, the sleep tracking device 110 may be hung over a top rail of the crib 5 via a hook or other fastener. In some embodiments, it may be preferable to place the sleep tracking device 110 in a location that the child 5 is unable to reach.

It should however be appreciated that the sleep tracking device 110 is not limited to any particular fastener shown here, nor is the sleep tracking device 110 limited to attaching directly to the crib 5 or hanging on the crib 5. It should also be appreciated that the sleep tracking device 110 is not limited to any configuration shown in these figures or discussed here.

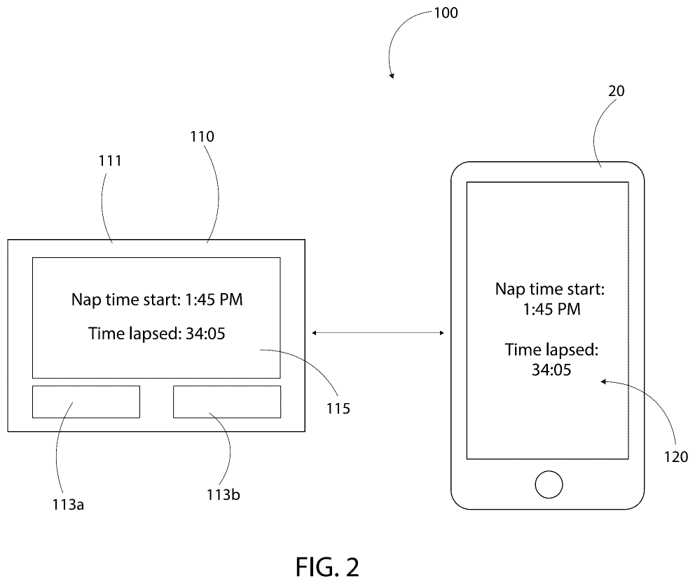

Referring now also to FIG. 2, which illustrates a diagram of the sleep tracking device 110 and a mobile device 20 having a software application 120 installed thereon, according to one or more embodiments of the present disclosure.

As discussed above, the sleep tracking device 110, generally, is configured to track time. Preferably, the user 15 is able to easily begin the timing via the sleep tracking device 110. As such, the sleep tracking device 110 may include a housing 111 including a user interface 113 disposed at an exterior of the housing 111. For example, as demonstrated in FIG. 1, the user interface 113 may include a start button 113 a, for starting the timing of the sleep tracking device 110; and a stop button 113 b, for stopping the timing of the sleep tracking device 110. This simple design may enable the user 15 to start and stop the sleep tracking device 110, perhaps one handed (if holding the child 10), in a hurry, etc. easily and conveniently.

As shown in FIG. 1, the sleep tracking device 110 may be configured to communicate with the mobile device 20 used by the user 15. In particular, the communication may be between the sleep tracking device 110 and the software application 120 installed on the mobile device 20. This communication between the sleep tracking device 110 and the software application 120 may enable the user 15 to view the time tracked by the sleep tracking device 110 directly from their mobile device 20. FIG. 1 demonstrates this, illustrating the user 15 checking the time from another room. This provides peace of mind to the user 15 and prevents the user 15 from having to disturb the child 10 to check the time on the sleep tracking device 110.

As shown in FIGS. 1-2, in some embodiments, the sleep tracking device 110 may further include a display 115 disposed at the exterior of the housing 111 and configured to display 115 the time tracked by the sleep tracking device 110. This display 115 may be particularly useful for enabling the user 15 to be sure that they have started timing of the sleep tracking device 110 prior to leaving the room.

Again, it should be appreciated that the sleep tracking device 110 is not limited to any configuration shown in these figures or discussed here. As such, the sleep tracking device 110 is not limited to the shape or size of the housing 111 shown here, is not limited to buttons as the user interface 113, is not limited to the display 115 shown here, or having a display 115 at all, etc.

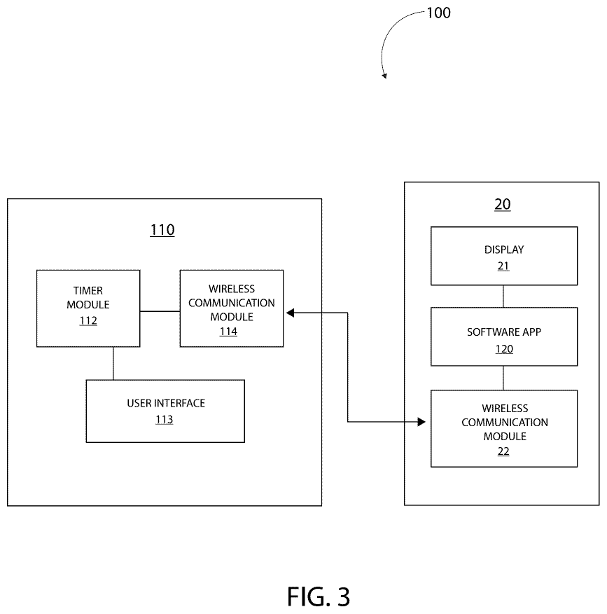

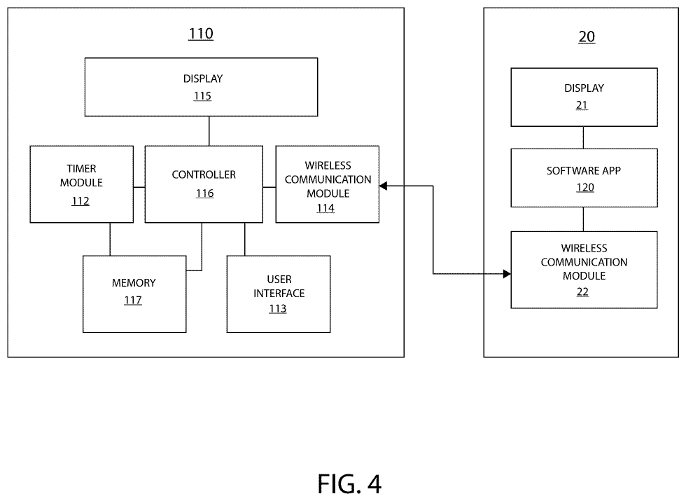

Referring now more specifically to FIGS. 3-4, there are shown schematic diagrams illustrating various components of the sleep tracking device 110 and the mobile device 20 that enable communication therebetween, according to one or more embodiments of the present disclosure. As shown here, the sleep tracking device 110 may include the user interface 113, a timer module 112 disposed in the housing 111, a wireless communication module 114 disposed in the housing 111; and in some embodiments, the display 115, and a controller 116 disposed in the housing 111.

The timer module 112 is configured to track time. As such, the timer module 112 may include a clock, a timer, a stopwatch, or the like. In embodiments comprising the controller 116, the controller 116 may be in communication with the timer module 112 and the wireless communication module 114. In some embodiments, the controller 116 may be configured to generate data pertaining to the time tracked by the timer module 112. In other embodiments, the timer module 112 and the wireless communication module 114 may include integral controllers or processors. As such, in some embodiments, the timer module 112 may be configured to generate the data pertaining to the time tracked.

The data pertaining to the time tracked by the timer module 112 may include time elapsed since the operation of the timer module 112 was started; and/or a time at which the operation of the timer module 112 was started. For example, once the user 15 starts operation of the timer module 112 (in some embodiments, via the user interface 113), data may be automatically generated pertaining to the time at which the operation of the timer module 112 was started. This information, in some embodiments, may also be displayed on the display 115 of the sleep tracking device 110.

As discussed above, the software application 120 may be installed on the mobile device 20 and in wireless communication with the sleep tracking device 110. As such, the wireless communication module 114 may facilitate this communication such that the wireless communication module 114 is able to transmit the data pertaining to the time tracked by the timer module 112 and the software application 120 is able to receive the data pertaining to the time tracked by the timer module 112. In some embodiments, the controller 116 may facilitate the transmittal of the data. In other embodiments, as above, the wireless communication module 114 may include an integral controller or processor able to facilitate the transmittal. In some embodiments, the wireless communication may be via BLUETOOTH, Wi-Fi, or the like.

To facilitate the communication, the mobile device 20 also includes a wireless communication module 22, a display 21, the software application 120 and other elements required for facilitation of the communication (such as a microprocessor, a memory, and the like). It should be appreciated that the mobile device 20 contemplated for use here may be a device known in the art, such as a smartphone, a laptop computer, a tablet computer, or the like; and as such, extensive discussion regarding the elements of the mobile device 20 will be omitted for the sake of brevity.

As demonstrated in FIG. 1, the user 15 of the mobile device 20 is able to view the time elapsed since the operation of the timer module 112 was started; and/or a time at which the operation of the timer module 112 was started via the software application 120. Further, in some embodiments, the starting and stopping of the timer module 112 may be achieved via the software application 120. This may be particularly useful for circumstances where the user 15 forgets to start the timer module 112 from the sleep tracking device 110; instead, they can start the timer module 112 from the software application 120 (using their mobile device 20) without having to go back into the room and disturbing the child 10.

As above, the data may be automatically generated pertaining to the time at which the operation of the timer module 112 was started. Further, in some embodiments, for the duration of the operation of the timer module 112, data may be being continually generated, to keep a live record of the time elapsed since the operation of the timer module 112 was started.

In some embodiments, the data may be kept locally on the sleep tracking device 110 until the data is requested by the user 15 of the software application 120. As such, as shown in FIG. 4, in some embodiments the sleep tracking device 110 may include a memory 117. This memory 117 may include RAM (Random Access Memory) capable of storing data for the current task (e.g., one sleep) and/or ROM (Read-Only Memory) capable of storing data related to multiple tasks (e.g., timings for many sleeps). Additionally, or instead of this, the data may be automatically sent to the software application 120. Additionally, or instead of this, the data may be automatically sent to a server, such as a cloud server, where it is stored and accessed via the software application 120.

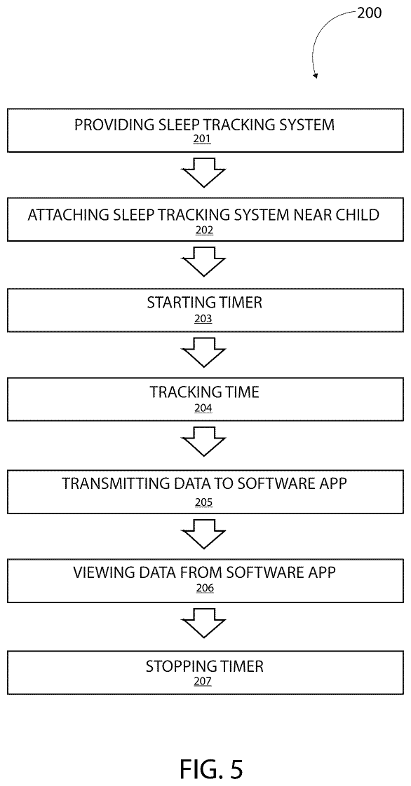

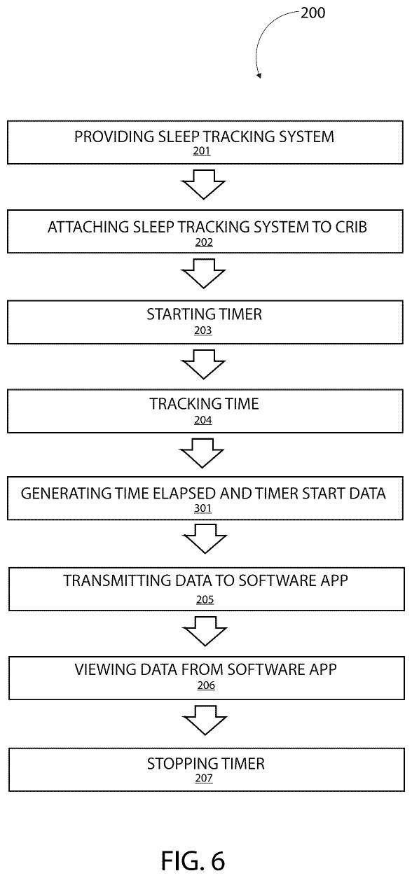

Referring now to FIGS. 5-6 showing flow diagram illustrating a method of tracking a child's sleep 200, according to an embodiment of the present disclosure. In particular, the method 200 may include one or more components or features of the sleep tracking system 100 as described above. As illustrated, the method 200 may include the steps of: step one 201, providing the sleep tracking system as above; step two 202, attaching, by a user, the sleep tracking device near to a sleeping child; step three 203, starting, by the user at the user interface or the software application, operation of the timer module; step four 204, tracking, by the timer module, time; step five 205, transmitting, by the wireless communication module, data pertaining to time tracked by the timer module to the software application on the mobile device; step six 206, viewing, by the user, the data pertaining to the time tracked by the timer module via the software application on the mobile device; and step seven 207, stopping, by the user at the user interface or the software application, operation of the timer module when desired (e.g., once the sleep is complete).

As illustrated in FIG. 6 and as discussed above, attaching the sleep tracking device (202) may include attaching, or hanging, the sleep tracking device to a crib; and transmitting the data (205) may comprise transmitting a time elapsed since the timer module was started and/or a time at which the timer module was started. Further, in embodiments including the controller discussed above, the method 200 may further comprise the step of generating (301) by the controller, the data pertaining to the time tracked by the timer module (prior to transmitting the data).

As also discussed above, the starting and stopping of the timer module can be achieved either via the user interface on the sleep tracking device, or via the software application. It should be appreciated that, in some circumstances, the starting of the timer module can be completed by one means; and the stopping of the timer module can be completed by another means. For example, the starting of the timer module may be completed through the software application; and stopping of the timer module may be completed through the user interface, or vice versa.

It should be noted that certain steps are optional and may not be implemented in all cases. It should also be noted that the steps described in the method 200 can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for of tracking a child's sleep are taught herein.

It should be understood by one of skill in the art that the disclosed invention is described here in a few exemplary embodiments of many. No particular terminology or description should be considered limiting on the disclosure or the scope of any claims issuing therefrom.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the relevant patent offices and the public generally, and especially the scientist, engineers and practitioners in the art who are not familiar with patent or legal terms or phraseology, to determine quickly from a cursory inspection the nature and essence of the technical disclosure of the application.

1. A sleep tracking system comprising:
a sleep tracking device for attachment near to a sleeping child, the sleep tracking device including a housing, a timer module disposed in the housing and configured to track time, a user interface disposed at an exterior of the housing and configured to start and stop operation of the timer module, and a wireless communication module disposed in the housing and configured to transmit data pertaining to the time tracked by the timer module; and
a software application installed on a mobile device and in wireless communication with the sleep tracking device via the wireless communication module such that the software application is able to receive the data pertaining to the time tracked by the timer module, thereby enabling a user of the mobile device to view the data pertaining to the time tracked by the timer module via the software application.

2. The sleep tracking system of claim 1, wherein the sleep tracking device further includes a display disposed at the exterior of the housing and configured to display the data pertaining to the time tracked by the timer module.

3. The sleep tracking system of claim 1, wherein the sleep tracking device further includes a controller disposed in the housing and in communication with the timer module and the wireless communication module.

4. The sleep tracking system of claim 3, wherein the controller is configured to generate the data pertaining to the time tracked by the timer module.

5. The sleep tracking system of claim 1, wherein the user interface includes a start button for starting the operation of the timer module and a stop button for stopping the operation of the timer module.

6. The sleep tracking system of claim 1, wherein the operation of the timer module is further able to be started and stopped via the software application.

7. The sleep tracking system of claim 1, wherein the data pertaining to the time tracked by the timer module includes time elapsed since the operation of the timer module was started.

8. The sleep tracking system of claim 1, wherein the data pertaining to the time tracked by the timer module further includes a time at which the operation of the timer module was started.

9. The sleep tracking system of claim 1, wherein the sleep tracking device is attached to a crib.

10. A sleep tracking device comprising:
a housing for attachment near to a sleeping child;
a timer module disposed in the housing and configured to track time;
a start button disposed at an exterior of the housing and configured to start operation of the timer module;
a stop button disposed at an exterior of the housing and configured to stop operation of the timer module;
a controller disposed in the housing and configured to generate data pertaining to time tracked by the timer module;
a display disposed at the exterior of the housing and configured to display the data pertaining to the time tracked by the timer module; and
a wireless communication module disposed in the housing and configured to transmit data pertaining to the time tracked by the timer module to a mobile device running a software application.

11. The sleep tracking device of claim 10, wherein the data pertaining to the time tracked by the timer module includes time elapsed since the operation of the timer module was started.

12. The sleep tracking device of claim 11, wherein the data pertaining to the time tracked by the timer module further includes a time at which the operation of the timer module was started.

13. The sleep tracking device of claim 10, wherein the operation of the timer module is further able to be started and stopped via the software application.

14. The sleep tracking device of claim 10, wherein the sleep tracking device is attached to a crib.

15. A method of tracking a child's sleep, the method comprising the steps of:
providing a sleep tracking system including:
a sleep tracking device having a housing, a timer module disposed in the housing, a user interface disposed at an exterior of the housing, and a wireless communication module disposed in the housing; and
a software application installed on a mobile device and in wireless communication with the sleep tracking device via the wireless communication module;
attaching, by a user, the sleep tracking device near to a sleeping child;
starting, by the user at one of the user interface and the software application, operation of the timer module;
tracking, by the timer module, time;
transmitting, by the wireless communication module, data pertaining to time tracked by the timer module to the software application on the mobile device;
viewing, by the user, the data pertaining to the time tracked by the timer module via the software application on the mobile device; and
stopping, by the user at one of the user interface and the software application, operation of the timer module when desired.

16. The method of claim 15, wherein transmitting the data comprises transmitting a time elapsed since the timer module was started.

17. The method of claim 16, wherein transmitting the data further comprises transmitting a time at which the timer module was started.

18. The method of claim 15, wherein the sleep tracking device includes a controller and the method further comprises the step of:
generating, by the controller, the data pertaining to the time tracked by the timer module.

19. The method of claim 15, wherein attaching the sleep tracking device comprises attaching the sleep tracking device to a crib.

20. The method of claim 19, wherein attaching the sleep tracking device comprises hanging the sleep tracking device on a crib.
